(19) United States
(12) Patent Application Publication
(10) Pub. No.: US 2024/0339763 A1
(43) Pub. Date: Oct. 10, 2024

(54) ANTENNA, ANTENNA MODULE, AND ELECTRONIC DEVICE

(71) Applicant: KYOCERA Corporation, Kyoto-shi, Kyoto (JP)

(72) Inventor: Tatsuya MORITA, Soraku-gun (JP)

(73) Assignee: KYOCERA Corporation, Kyoto-shi, Kyoto (JP)

(21) Appl. No.: 18/292,128

(22) PCT Filed: Jul. 15, 2022
(86) PCT No.: PCT/JP2022/027832

§ 371 Date: Jan. 25, 2024

(30) Foreign Application Priority Data
Jul. 27, 2021 (JP) 2021-122146

(51) Int. Cl. H01Q 19/00; H01Q 9/04; H01Q 23/00

(52) U.S. Cl. CPC H01Q 19/005; H01Q 9/0407; H01Q 23/00

(57) ABSTRACT

An antenna includes a reference potential layer, a feed element, a parasitic element, and at least one connecting conductor. The reference potential layer extends in a first direction and a second direction orthogonal to the first direction. The feed element is composed of a layered conductor facing the reference potential layer. Further, the feed element has a first feed point at a position toward one side in the first direction relative to a center of the feed element in the first direction. The parasitic element is composed of a layered conductor facing the feed element from a side opposite the reference potential layer. The connecting conductor is connected to the feed element and the parasitic element at a position closer to the center of the feed element than the first feed point in first direction, and is not electrically connected to the reference potential layer.

### TECHNICAL FIELD

The present disclosure relates to an antenna, an antenna module including the antenna, and an electronic device including the antenna module.

### BACKGROUND OF INVENTION

Patch antennas with parasitic elements are known (see, for example, Patent Literature 1 below). The patch antenna described in Patent Literature 1 includes a reference potential layer, a feed element, and a parasitic element. The feed element is composed of a layered conductor (patch) facing the reference potential layer. The feed element is connected to a high-frequency circuit at its feed point. In other words, the feed element is fed with power. The parasitic element is composed of a layered conductor (patch) facing the feed element from a side opposite the reference potential layer. The parasitic element is not fed with power, and contributes to widening bandwidth by generating multiple resonances with the feed element.

Patent Literature 1 suggests grounding the parasitic element in view of the fact that when the parasitic element is charged by the radiation in space and then discharged, noise is generated in communications. Specifically, the center of the parasitic element is connected to the reference potential layer by a metal pin. The center of the feed element is also connected to the metal pin. Patent Literature 1 describes that since the electric field at the center of the antenna is zero, connecting the metal pin does not cause any disturbance of the electromagnetic field and does not change the radiation pattern and input impedance.

### CITATION LIST

### Patent Literature

Patent Literature 1: Japanese Unexamined Patent Application Publication No. 9-98016

### SUMMARY

In an aspect of the present disclosure, an antenna includes a reference potential layer, a feed element, a parasitic element, and at least one connecting conductor. The reference potential layer extends in a first direction and a second direction orthogonal to the first direction. The feed element is composed of a layered conductor facing the reference potential layer. Further, the feed element includes a first feed point at a position toward one side in the first direction relative to a center of the feed element in the first direction. The parasitic element is composed of a layered conductor facing the feed element from a side opposite the reference potential layer. The at least one connecting conductor is connected to the feed element and the parasitic element at a position closer to the center of the feed element than the first feed point in the first direction, and is not electrically connected to the reference potential layer.

In an aspect of the present disclosure, an antenna includes a feed element, a parasitic element, and at least one connecting conductor. The feed element is composed of a layered conductor extending in a first direction and a second direction orthogonal to the first direction. Further, the feed element includes a first feed point at a position toward one side in the first direction relative to a center of the feed element in the first direction. The parasitic element is composed of a layered conductor facing the feed element. The at least one connecting conductor is connected to the feed element and the parasitic element at a position closer to the center of the feed element than the first feed point in the first direction. Further, the at least one connecting conductor includes a plurality of connecting conductors whose positions in the second direction are different from each other.

In an aspect of the present disclosure, an antenna includes a feed element, a parasitic element, and at least one connecting conductor. The feed element is composed of a layered conductor extending in a first direction and a second direction orthogonal to the first direction. Further, the feed element includes a first feed point at a position toward one side in the first direction relative to a center of the feed element in the first direction. The parasitic element is composed of a layered conductor facing the feed element. The at least one connecting conductor is connected to the feed element and the parasitic element at a position closer to the center of the feed element than the first feed point in the first direction. Further, the at least one connecting conductor includes a connecting conductor whose length in the first direction is equal to or greater than 1/10 of a length of the feed element in the first direction.

In an aspect of the present disclosure, an antenna module includes the above-described antenna and an IC (integrated circuit) connected to the first feed point.

In an aspect of the present disclosure, an electronic device includes the above-described antenna module and a housing that houses the antenna module.

### BRIEF DESCRIPTION OF THE DRAWINGS

FIG. 1 is a perspective view of an antenna of a first embodiment.

FIG. 2 is a cross section taken along line II-II of FIG. 1.

FIG. 3 is a transparent plan view of a portion of the antenna illustrated in FIG. 1.

FIG. 4A is a transparent plan view of a variation of a connecting conductor.

FIG. 4B is a transparent plan view of another variation of the connecting conductor.

FIG. 5A is a transparent plan view of further another variation of the connecting conductor.

FIG. 5B is a transparent plan view of further another variation of the connecting conductor.

FIG. 6 is a graph showing the characteristics of antennas of examples and a comparative example.

FIG. 7 is another graph showing other characteristics of the antennas of the examples and the comparative example.

FIG. 8 a graph showing a portion of FIG. 7.

FIG. 9A is a plan view schematically illustrating an electric field distribution in the antenna of the comparative example.

FIG. 9B is a plan view schematically illustrating an electric field distribution in the antenna of one of the examples.

FIG. 10 is a perspective view of an antenna of a second embodiment.

FIG. 11 is a transparent plan view illustrating a portion of the antenna of FIG. 10.

FIG. 12 is a graph showing the characteristics of the antenna of the second embodiment.

FIG. 13 is another graph showing other characteristics of the antenna of the second embodiment.

FIG. 14 is a view schematically illustrating a configuration of an electronic device of an embodiment.

### DESCRIPTION OF EMBODIMENTS

Embodiments of the present disclosure will be described below with reference to the attached drawings. The drawings used in the following description are schematic, and the dimensional proportions and the like of the drawings do not necessarily correspond to reality. Also, the drawings and/or descriptions may omit details. Thus, for example, even though the term “rectangle” is used, the corners may be chamfered to a size that does not have a significant effect on the characteristics and the like of the antenna.

Also, for convenience, a Cartesian coordinate system xyz, which is fixed to the antenna, is attached to the drawings and may be referred to. Any direction in the Cartesian coordinate system xyz can be considered the top or bottom of the antenna, but for convenience, the positive side of the z-direction is considered the top of the antenna, and the terms “upper surface”, “lower surface” and the like may be used. The plan view is viewed in the z-direction, unless otherwise noted.

The antenna can be used for transmission and/or reception. For convenience, however, only transmission may be described. Also, by convention, terms that evoke transmission, such as “feed point”, may be used regardless of whether the antenna is used for transmission or not. The wavelength in the description of the embodiments is the wavelength of radio waves having the frequency targeted by the antenna (for example, the center frequency of a given band), unless otherwise noted.

The following description is generally made in the following order.
Antenna of first embodiment
Antenna of second embodiment
Applications of antenna

### First Embodiment

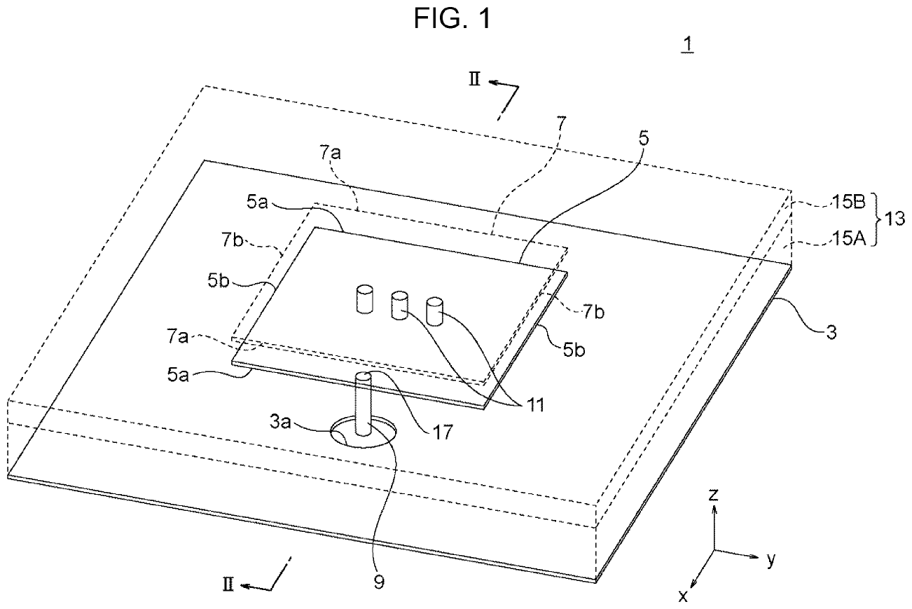

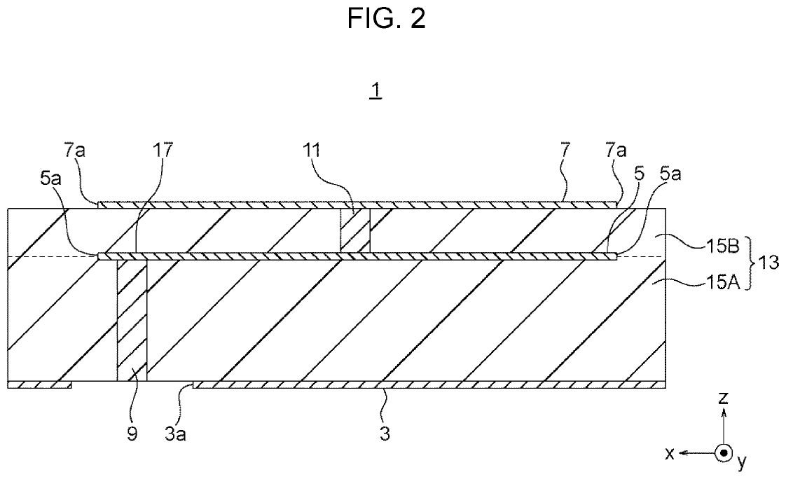

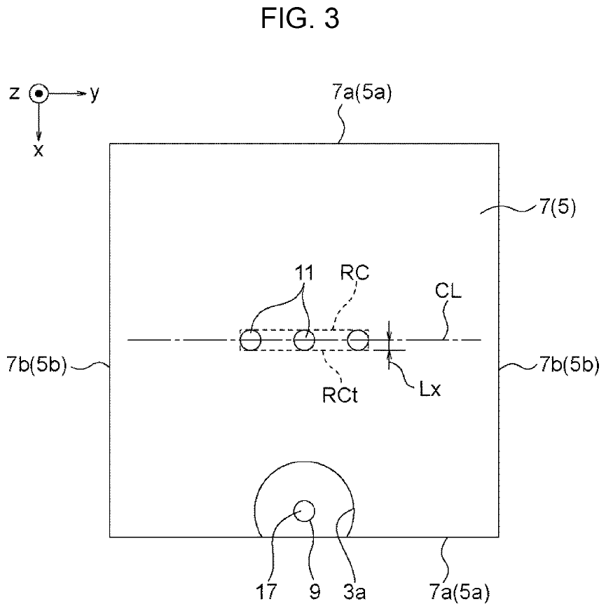

FIG. 1 is a perspective view illustrating a configuration of an antenna 1 of the first embodiment. FIG. 2 is a cross section taken along line II-II of FIG. 1. FIG. 3 is a transparent plan view of a portion of the antenna 1 (more specifically, a range overlapping a parasitic element 7, which is to be described later). In FIG. 1, an upper portion of the antenna 1 is viewed through as dotted lines. In FIG. 1, an upper portion of a feeding conductor 9 (which will be described later) is hidden by a feed element 5 (which will be described later) and therefore is not visible, but is indicated by a solid line for convenience of illustration. In FIG. 3, members hidden by the upper members and therefore are not visible are also indicated by solid lines.

The antenna 1 includes layered conductors (a reference potential layer 3, the feed element 5, and the parasitic element 7) that are stacked on top of each other. The feed element 5 is connected to a high-frequency circuit via the feeding conductor 9 connected to a feed point 17 of the feed element 5 (in other words, is fed with power) to transmit and/or receive radio waves. The parasitic element 7 is not fed with power, and contributes to obtaining a wider bandwidth by, for example, generating multiple resonances with the feed element 5.

Furthermore, the antenna 1 includes at least one (three, in the example illustrated in the drawings) connecting conductor 11 connecting the feed element 5 to the parasitic element 7. Owing to the connecting conductor 11, for example, the bandwidth of the antenna 1 is further widened. The connecting conductor 11 differs in various respects from a conductor (for example, the above-described metal pin of Patent Literature 1) simply for discharging the parasitic element 7. For example, the connecting conductor 11 is not connected to the reference potential layer 3.

The parts of the antenna 1 other than the connecting conductor 11 may be configured in various forms, for example in a known form. Description of the parts that may be configured in a known form may be omitted as appropriate.

In addition to the above components, the antenna 1 includes, for example, a dielectric 13 on which the above-described layered conductors (3, 5 and 7) are arranged. The dielectric 13, for example, contributes to the support of the layered conductors and to the miniaturization of the antenna 1 by shortening the effective wavelength.

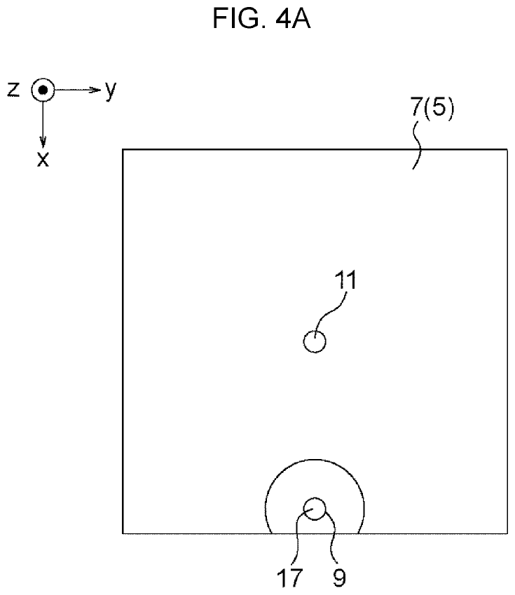

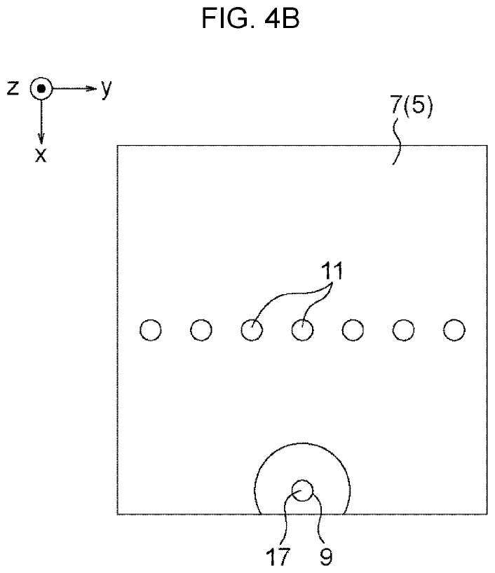

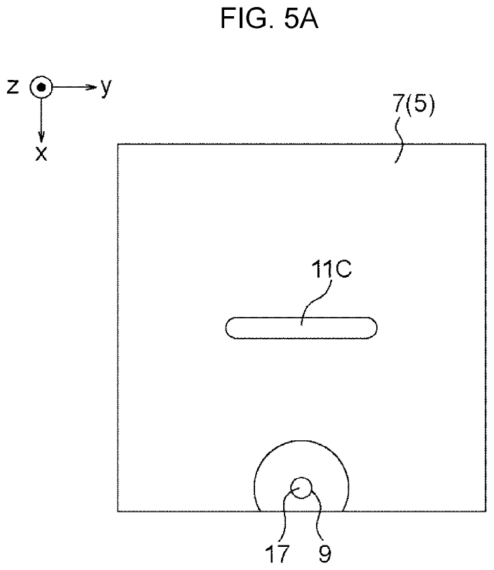

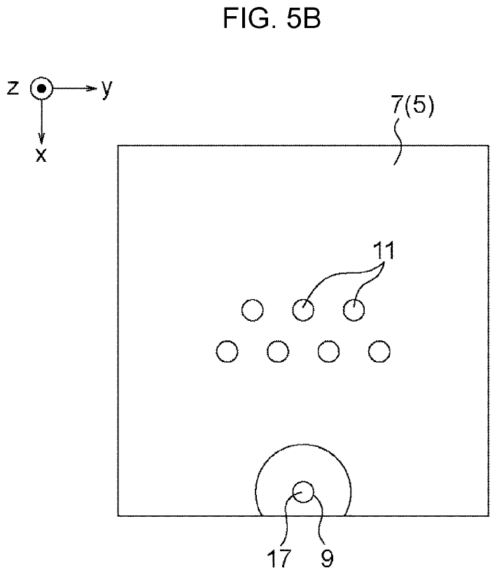

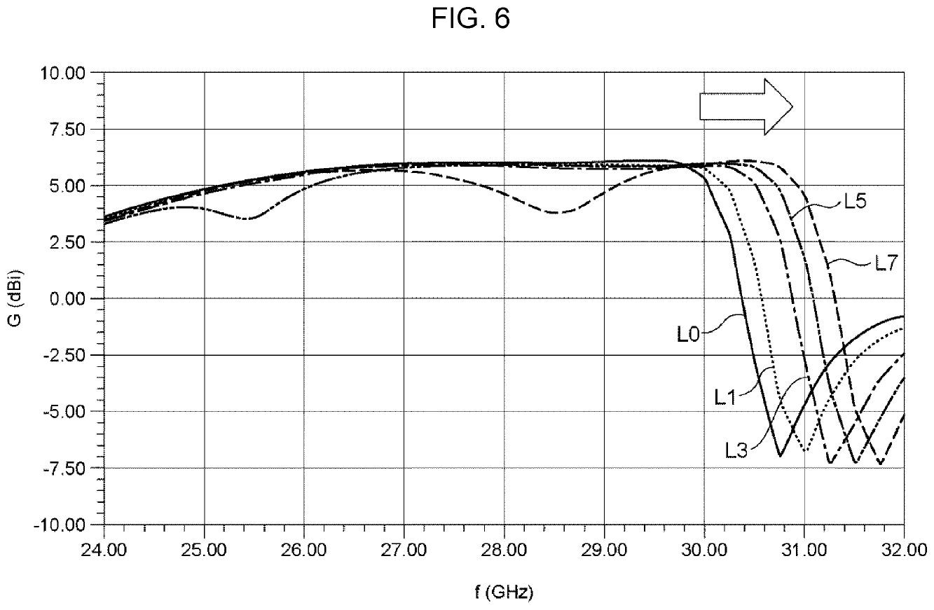

The present embodiment is described roughly in the following order.
Overview of antenna 1
Matters common to various conductors (3, 5, 7, 9 and 11)
Dielectric 13
Reference potential layer 3
Feed element 5
Parasitic element 7
Feeding conductor 9 (feed point 17)
Connecting conductor 11
Variations of connecting conductor 11 (FIG. 4A to FIG. 5B)
Action of connecting conductor 11 (FIG. 6 to FIG. 9)
Summary of first embodiment

### (Overview of Antenna)

The antenna 1 is configured to transmit and/or receive a linearly polarized wave. The oscillation direction of the electric field of the linearly polarized wave subject to transmission and/or reception is in the x-direction. The direction with the highest gain in the antenna 1 is the +z-direction. The antenna 1 is used in any frequency band. The antenna 1 may also be used for transmitting and/or receiving other polarized waves (for example, a circularly polarized wave).

The shape of the antenna 1 is roughly a flat plate with a constant thickness. The configuration of the antenna 1, for example, is line symmetrical with respect to a symmetric axis (not illustrated) parallel to the x-direction in plan view. Although not particularly illustrated, other members (for example, a dielectric layer) may be superimposed on the upper surface and/or lower surface of the antenna 1. In another point of view, the flat plate shape illustrated in the drawings may be a part of a member (for example, a substrate with the z-direction as the thickness direction) that includes the antenna 1.

The planar shape of the antenna 1 (the dielectric 13, in another point of view) illustrated in FIG. 1 is, for example, only the shape of a part of a flat plate (a substrate) including the antenna 1, which is cut out for convenience of illustration. In other words, the side surfaces of the antenna 1 illustrated in the drawings are cross-sections of the above-described substrate and do not necessarily indicate the extent of the antenna 1. However, the side surfaces illustrated in FIGS. 1 and 2 may be actual side surfaces of the antenna 1. The side surfaces of the antenna 1 illustrated in the drawings may be perceived as indicating the extent of the antenna 1, regardless of whether the antenna 1 is a part of the substrate or not. In a form in which the planar shape of the antenna 1 can be specified, the planar shape may be any shape. For example, the planar shape of the antenna 1 may be rectangular (as in the example illustrated in the drawings), other polygonal shapes, circular or oval.

The size of the antenna 1 may be set as appropriate according to the frequency band and the like in which the antenna 1 is used. In the following description, a form in which the antenna 1 is a relatively small one used in a relatively high frequency band will be described as an example. For example, the antenna 1 may be used in a frequency band of 300 MHz or higher, or a frequency band of 3 GHz or higher, or may be used in a frequency band of 30 GHz or lower, or a frequency band of 300 GHz or lower. The lower limits and upper limits described above may be combined as appropriate. For example, the length of the range (or the feed element 5) illustrated in the drawings in each of the x-direction and the y-direction may be from 1 mm to 100 mm inclusive. The thickness of the antenna 1 may be, for example, from 0.1 mm to 10 mm inclusive. Such a relatively small antenna 1 may be configured, for example, as an electronic component to be incorporated into an electronic device. However, the size of the antenna 1 may be equal to or larger than tens of centimeters or equal to or larger than several meters in plan view.

### (Matters Common to Various Conductors)

Each layered conductor (each of the reference potential layer 3, the feed element 5, and the parasitic element 7), for example, extends basically without gaps, in a so-called solid pattern. Each layered conductor generally has a constant thickness throughout. The thickness of each layered conductor may be set appropriately considering the characteristics of the antenna 1. The thickness of the layered conductor may be thinner than the thickness of the dielectric layer. For example, the thickness of the layered conductor is from 1 μm to 1 mm inclusive.

The materials of the various conductor members (3, 5, 7, 9 and 11, as well as the other conductor members described later) are, for example, metal. The metal may be a suitable one such as Cu, Al or the like. The materials of the various conductor members may be identical or different from each other. Each conductor member may be composed of a single material or a plurality of materials. Examples of the latter include a layered conductor composed of layers of different materials stacked on top of each other.

In terms of material and the like, in a connecting portion between the layered conductor (3, 5 or 7) and the shaft-like conductor (9 or 11) orthogonal to the layered conductor, the upper surface or the lower surface of the layered conductor and the end surface of the shaft-like conductor may be joined to each other, the shaft-like conductor may pass through the conductor layer, or such a distinction may be impossible. For convenience, in the following description, a form in which the shaft-like conductor is joined to the upper surface or lower surface of the layered conductor may be discussed as an example.

### (Dielectric)

The description of the planar shape and dimensions in plan view of the antenna 1 (as described above) may be applied to the planar shape and dimensions in plan view of the dielectric 13. The thickness of the dielectric 13 may be set appropriately to improve the antenna characteristics. The setting method may be, for example, the same as that for a known patch antenna.

The reference potential layer 3 is superimposed on the lower surface of the dielectric 13. The feed element 5 is embedded in the dielectric 13 in an orientation parallel to the upper surface and lower surface of the dielectric 13. The parasitic element 7 is superimposed on the upper surface of the dielectric 13. Note that, different from the example illustrated in the drawings, the reference potential layer 3 and the feed element 5 may be embedded in the dielectric 13 in an orientation parallel to the upper surface and lower surface of the dielectric 13.

The dielectric 13 may be perceived as including a first dielectric layer 15A located between the reference potential layer 3 and the feed element 5, and a second dielectric layer 15B located between the feed element 5 and the parasitic element 7. The first dielectric layer 15A and the second dielectric layer 15B may have a configuration such that their boundaries can be specified in terms of material and the like, or a configuration such that they are integral with each other and are conceptually distinguished simply by the presence of the feed element 5.

The dielectric 13 (or dielectric layer) may be composed of a single material or a plurality of materials. When composed of a plurality of materials, for example, the dielectric 13 (or dielectric layer) may be composed of dielectric layers made of different materials laminated in the thickness direction and/or a base material made of glass cloth or the like impregnated with a dielectric. The material of the dielectric 13 is, for example, ceramic and/or resin. For example, the specific dielectric constant of the dielectric 13 is from 2.0 to 4.0 inclusive.

### (Reference Potential Layer)

As described above, the reference potential layer 3 extends without gaps and has a so-called solid pattern. However, the reference potential layer 3 includes an opening 3a at a position of the feeding conductor 9 so that the reference potential layer 3 does not short-circuit with the feeding conductor 9. The shape and diameter of the opening 3a may be set as appropriate. The following description may include expressions that ignore the presence of the opening 3a. The reference potential layer 3 is arranged in a first direction and a second direction orthogonal to the first direction. Here, the first direction and the second direction correspond to the x-direction and the y-direction in the Cartesian coordinate system xyz described above. The first direction is, for example, the x-direction in FIG. 1. The second direction is, for example, the y-direction in FIG. 1.

The reference potential layer 3 has at least a size that overlaps, for example, the entirety of the feed element 5 and/or the parasitic element 7 in a transparent plan view. The outer edge of the reference potential layer 3, for example, is located entirely outside the outer edge of the feed element 5 and/or the parasitic element 7. The reference potential layer 3 may extend over the entire dielectric 13, or may have part or all of its outer edge located within the outer edge of the dielectric 13.

The reference potential to the reference potential layer 3 may be provided by an appropriate method. For example, the reference potential layer 3 may be electrically connected to signal ground and/or frame ground via a conductor of a circuit board on which the antenna 1 is mounted and/or via a conductor of a circuit board which includes the antenna 1.

### (Feed Element)

The planar shape of the feed element 5 may be, for example, of various shapes that enable transmission and/or reception of a linearly polarized wave in the x-direction. Such shapes can be, for example, rectangular (as in the example illustrated in the drawings) and circular. The rectangular shape has two sides parallel to the x-direction and two sides parallel to the y-direction. The rectangular shape may be a square (as in the example illustrated in the drawings) or a rectangle (other than a square). In order to improve the characteristics, the outer edge of the feed element 5 may be deformed based on the shape illustrated above, or slits may be provided.

The feed element 5 may be configured, for example, as a half-wavelength patch. In the half-wavelength patch, the lengths in the x-direction and y-direction are based on ½×λg. λg is the effective wavelength at the position of the feed element 5, taking into account the dielectric constant and the like of the dielectric 13. The reason for using ½×λg as the basis is that in simple theory ½×λg may be used, whereas in practice a length adjusted from ½×λg may be used.

### (Parasitic Element)

The description of the planar shape of the feed element 5 may be basically applied to the planar shape of the parasitic element 7. The planar shape of the parasitic element 7 may be identical to the planar shape of the feed element 5 (as in the example illustrated in the drawings), or different from the planar shape of the feed element 5. Examples of the latter include a configuration in which one of the feed element 5 and the parasitic element 7 is circular and the other is rectangular, and a configuration in which both the feed element 5 and the parasitic element 7 are rectangular (or circular) but the dimensions of the feed element 5 and the parasitic element 7 are different from each other.

The parasitic element 7 is arranged so that, for example, the center of the parasitic element 7 in the x-direction coincides with the center of the feed element 5 in the x-direction, in a transparent plan view. In the example illustrated in the drawings, the feed element 5 and the parasitic element 7 have identical shapes to each other. Thus, in another point of view, edges 5a on both sides of the feed element 5 in the x-direction and edges 7a on both sides of the parasitic element 7 in the x-direction coincide with each other in a transparent plan view.

The parasitic element 7 is arranged so that, for example, the center of the parasitic element 7 in the y-direction coincides with the center of the feed element 5 in the y-direction, in a transparent plan view. In the example illustrated in the drawings, the feed element 5 and the parasitic element 7 have identical shapes to each other. Thus, in another point of view, edges 5b on both sides of the feed element 5 in the y-direction and edges 7b on both sides of the parasitic element 7 in the y-direction coincide with each other in a transparent plan view.

As will be understood from the above description, in the example illustrated in the drawings, the entire outer edge of the feed element 5 and the entire outer edge of the parasitic element 7 coincide in a transparent plan view. Thus, in FIG. 3, the sign for the feed element 5 is also shown in parentheses after the sign for the parasitic element 7.

Note that even if the centers or edges of the parasitic element 7 and the feed element 5 coincide, needless to say, there may be tolerances. Further, different from the example illustrated in the drawings, the centers and/or edges of the parasitic element 7 and the feed element 5 may be displaced with respect to each other for fine tuning of the characteristics. When the planar shape of the feed element 5 or the parasitic element 7 is not rectangular or circular, the centers thereof in the x-direction or y-direction may be reasonably specified. For example, if there is a specific portion on the edge, such a specific portion may be ignored. For example, the position of a line bisecting the area of the element in the x-direction may be specified as the center in the x-direction.

### (Feeding Conductor)

The feeding conductor 9 is composed, for example, of a shaft-like conductor (a via conductor) that passes through the first dielectric layer 15A. The specific shape and dimensions of the feeding conductor 9 may be set as appropriate. In the example illustrated in the drawings, the feeding conductor 9 is cylindrical and straight, with the z-direction as the axial direction. The upper end of the feeding conductor 9 is connected to the feed element 5. The lower end portion of the feeding conductor 9 is exposed to the outside through the opening 3a of the reference potential layer 3 and can be connected to an external device (for example, a high-frequency circuit).

The connecting portion of the feed element 5 to the feeding conductor 9 is the feed point 17. Although the word “point” is used by convention, the feed point does not need to be point-shaped. The position of the center (for example, geometric center) of the feed point 17 may be referred to in the description of the position of the feed point 17. The feed element 5 at the position of the feed point 17 need not have a different configuration from other regions within the feed element 5, and the feed point 17 may be specified from the relationship with another member (the feeding conductor 9, in the example illustrated in the drawings).

The position of the feed point 17 within the feed element 5 in plan view is any position. For example, the position of the feed point 17 in the x-direction may be set so that the impedance at the feed point 17 becomes a predetermined value (for example, 50Ω. Usually, such a position is off toward one side in the x-direction relative to the center of the feed element 5 in the x-direction. The adjustment of the impedance may be realized by an external device connected to the feeding conductor 9. The position of the feed point 17 in the y-direction may be, for example, the center of the feed element 5 in the y-direction.

Although not particularly illustrated in the drawings, power can be fed to the feed element 5 in a variety of manners other than that illustrated in the drawings. For example, the feeding conductor may be composed of a strip (an elongated layered conductor) extending parallel to the xy-plane from one edge of the feed element 5 in the x-direction. In such a case, the strip may be connected, for example, to the edge 5a (one side of the rectangle) of the feed element 5, or connected to the feed element 5 via a cutout in the edge 5a. The cutout is provided, for example, to adjust the impedance by adjusting the distance between the feed point (the connection position between the strip and the feed element 5) and the edge 5a.

For example, the form in which the feed element 5 is rectangular or circular and/or the form in which the edges 5a of the feed element 5 coincide with the edges 7a of the parasitic element 7 includes the form in which the above-described cutout for feeding power is configured.

### (Connecting Conductor)

The connecting conductor 11 is composed, for example, of a shaft-like conductor (a via conductor) that passes through the second dielectric layer 15B. The specific shape and dimensions of the connecting conductor 11 may be set as appropriate. In the example illustrated in the drawings, the connecting conductor 11 is cylindrical and straight, with the z-direction as the axial direction. For example, the diameter of the connecting conductor 11 may be less than, equal to (as in the example illustrated in the drawings), or greater than the diameter of the feeding conductor 9.

Although not particularly illustrated in the drawing, the connecting conductor 11 may have various shapes other than the example illustrated in the drawings, for example, various known shapes as a via conductor. For example, the via conductor may consist of a plurality of smaller via conductors placed in a line. In such a case, steps and/or flanges may be formed between the smaller via conductors. The via conductor (including the smaller via conductors described above; the same applies hereinafter) may be tapered (pyramid-shaped), with the diameter decreasing upward or downward. Further, the via conductor may be hollow. In such a case, the inside of the via conductor may be vacuumed, filled with a gas or filled with an insulating material.

In a transparent plan view, the region where all (three, in the example illustrated in the drawings) connecting conductors 11 are located is referred to as a connection region RC (see FIG. 3). The connection region RC may be perceived as a region of the feed element 5 or the parasitic element 7 to which the connecting conductors 11 are connected. The connection region RC may, for example, be the smallest rectangular region that includes all connecting conductors 11 (or upper end surfaces or lower end surfaces thereof) in a transparent plan view.

The connection region RC is located at a position closer to the center of the feed element 5 than the feed point 17 in the x-direction. In other words, the distance from the center of the feed element 5 in the x-direction (a center line CL) to the connection region RC (for example, an edge RCt of the connection region RC on the feed point 17 side) (i.e., a length Lx parallel to the x-direction) is shorter than the distance from the center line CL to the feed point 17 (i.e., a length parallel to the x-direction). Furthermore, in the example illustrated in the drawings, the connection region RC is located within a central length range (not illustrated) of the feed element 5 obtained when the length of the feed element 5 in the x-direction is divided into three or five equal parts. Furthermore, the connection region RC overlaps the center line CL. Furthermore, a center line of the connection region RC parallel to the y-direction overlaps the center line CL. Obviously, different from the example illustrated in the drawings, the connection region RC may be located at a position shifted, in the x-direction, toward the −x side or +x side relative to the center line CL.

In the description of the position and size of the connection region RC (or the connecting conductors 11), when the feed element 5 is not rectangular, the length of the feed element 5 in the x-direction may be, for example, the maximum length (however, the part caused by the specific portion of the edge 5a is excluded). The same applies to the length of the feed element 5 in the y-direction.

The length of the connection region RC in the x-direction may be set as appropriate. For example, the length of the connection region RC in the x-direction may be equal to or less than ⅕ or equal to or less than 1/10 of the length of the feed element 5 in the x-direction, or may be equal to or greater than 1/100, equal to or greater than 1/50, or equal to or greater than 1/20 of the length of the feed element 5 in the x-direction. The above upper limits and lower limits may be combined as appropriate.

The connection region RC may be located over a part of the feed element 5 (as in the example illustrated in the drawings) or over the entire feed element 5 in the y-direction. In the former case, for example, the connection region RC may be located so that its range is centered at the center of the feed element 5 in the y-direction, and its length in the y-direction is within 9/10, 8/10, 7/10 or 6/10 of the length of the feed element 5 in the y-direction. In other words, the distance between the connection region RC and each of the edges 5b on both sides in the y-direction may be equal to or greater than 1/20, 2/20, 3/20 or 4/20. For example, the connection region RC may be arranged so that its center in the y-direction is located at the center of the feed element 5 in the y-direction. Obviously, different from the example illustrated in the drawings, the center of the connection region RC in the y-direction may be shifted from the center of the feed element 5 in the y-direction to the −y side or +y side.

The length of the connection region RC in the y-direction may be set as appropriate. For example, the length of the connection region RC in the y-direction may be 9/10 or less, 8/10 or less, 7/10 or less, or 6/10 or less of the length of the feed element 5 in the y-direction, or 1/100 or more, 1/50 or more, 1/20 or more, 1/10 or more, ⅕ or more, ⅓ or more, ½ or more, 6/10 or more, or 7/10 or more of the length of the feed element 5 in the y-direction. The above upper limits and lower limits may be combined as appropriate, as long as there is no inconsistency.

In the above description, the upper limits and lower limits for the position and length of the connection region RC in the x-direction and the position and length of the connection region RC in the y-direction are described as examples. These upper limits and lower limits may be combined as appropriate with different parameters as long as there is no inconsistency or the like.

In the above description, the relationship between the position and size of the connection region RC and the position and size of the feed element 5 is described. Such a description may be applied to the relationship between the position and size of the connection region RC and the position and size of the parasitic element 7. That is, in the above description, the term “feed element 5” may be replaced by the term “parasitic element 7”. Note that, as described above, the positions, shapes, and dimensions of the feed element 5 and the parasitic element 7 in plan view may be identical to each other (as in the example illustrated in the drawings), or different from each other. As will be understood from this, the relationship between the position and size of the connection region RC and the position and size of the feed element 5 and the relationship between the position and size of the connection region RC and the position and size of the parasitic element 7 may be identical (as in the example illustrated in the drawings) or different from each other.

In the above description of the position and size of the connection region RC, the term “connection region RC” may be replaced by the term “a plurality (all) of connecting conductors 11”, as long as there is no inconsistency or the like. The description of the length of the connection region RC in the x-direction may be applied to the length of the connecting conductor 11 in the x-direction and/or the diameter of the connecting conductor 11 (or the circle equivalent diameter if the xy-section is not circular).

The number and arrangement of the connecting conductor(s) 11 that achieve the position and size of the connection region RC as described above may be any number and arrangement. For example, the number of the connecting conductor(s) 11 may be one, two or more (as in the example illustrated in the drawings), an odd number (as in the example illustrated in the drawings), or an even number. The plurality of connecting conductors 11 may be lined up in a single row (as in the example illustrated in the drawings), in two or more rows, or distributed in a manner that makes it difficult to perceive them as being lined up. When the plurality of connecting conductors 11 is lined up, the intervals (or pitches, in another point of view) may be constant (as in the example illustrated in the drawings) or not constant. The gap between adjacent connecting conductors 11 may be smaller than, equal to, or larger than (as in the example illustrated in the drawings) the diameter of the connecting conductors 11.

In the example illustrated in the drawings, the three connecting conductors 11 are lined up in a single row (or in a straight line, in another point of view) parallel to the y-direction. The intervals between the connecting conductors 11 are equal. The row of connecting conductors 11 is located on the center line CL. In the y-direction, the central one of the three connecting conductors 11 is located at the center of the feed element 5 (the parasitic element 7) in the y-direction. The other even number of connecting conductors 11 are arranged symmetrically on both sides of the central connecting conductor 11.

### (Variations of Connecting Conductor(s))

FIGS. 4A to 5B are transparent plan views illustrating variations of the connecting conductor(s) 11 (in another point of view, the connection region RC), and are equivalent to FIG. 3.

As illustrated in FIG. 4A, there may be only one connecting conductor 11. To be more specific, the example illustrated in FIG. 4A is obtained as a result of, in the example illustrated in FIG. 3, two of the three connecting conductors 11 on each side being eliminated.

As illustrated in FIG. 4B, the connecting conductors 11 may be arranged in such a manner that the connecting conductors 11 can be perceived as being arranged over the entire y-direction of the feed element 5 (the parasitic element 7). To be more specific, the example illustrated in FIG. 4B is obtained when, in the example illustrated in FIG. 3, four connecting conductors 11 are added on both sides of the three connecting conductors 11 (two connecting conductors 11 on each side) at equal intervals (the intervals are the same as in the example illustrated in FIG. 3). At least one connecting conductor 11 includes a plurality of connecting conductors 11 whose positions in the y-direction differ from each other. The plurality of connecting conductors 11 is arranged in different positions in the y-direction from each other.

As illustrated in FIG. 5A, a connecting conductor 11C may be shaped so that its length in the y-direction is longer than its length in the x-direction. In other words, the connecting conductor 11C may have a plate-like (layered) shape intersecting the xy-plane instead of a shaft-like shape. The length of the connecting conductor 11C in the y-direction may be set as appropriate. For example, the length of the connecting conductor 11C in the y-direction may be equal to or greater than twice or five times the length in the x-direction. Although not particularly illustrated, a plurality of connecting conductors 11C may be lined up in the y-direction or the like.

As illustrated in FIG. 5B, the connecting conductors 11 may be arranged in two or more rows. When the connecting conductors 11 are arranged in two or more rows, the numbers of the connecting conductors 11 in respective rows may be different from each other (as in the example illustrated in the drawings) or identical to each other. The positions of the connecting conductors 11 arranged in one and the other of the two rows may be different from each other in the y-direction (as in the example illustrated in the drawings), or identical to each other.

### (Action of Connecting Conductor)

Specific materials, dimensions and the like are set for the antenna of the embodiment, and the characteristics have been investigated by performing simulation calculations. As a result, it was confirmed that a wider bandwidth is achieved by the connecting conductor 11. Details are as follows.

FIG. 6 is a graph showing the characteristics of antennas of examples and a comparative example. In the graph shown in FIG. 6, the horizontal axis represents the frequency f (GHz). The vertical axis represents the gain G (dBi).

The line L0 indicates the characteristics of the comparative example. The comparative example does not include the connecting conductor 11. The lines L1, L3, L5 and L7 indicate the characteristics of four examples in which the numbers of connecting conductors 11 differ from each other. Specifically, in the examples of lines L1, L3, L5 and L7, the numbers of the connecting conductors 11 are one, three, five and seven, respectively. The conditions, except for the number of the connecting conductors 11, are identical to each other in the comparative example and the four examples.

In the examples with one, three and seven connecting conductors, the connecting conductors 11 are arranged as illustrated in FIG. 3, FIG. 4A and FIG. 4B. In the example with five connecting conductors 11, two connecting conductors 11 on both sides of the y-direction are eliminated from the example with seven connecting conductors 11.

As illustrated in FIG. 6, due to the provision of at least one connecting conductor 11, the range of frequencies where the gain is relatively high is extended to the high frequency side. In other words, a wider bandwidth is achieved. Further, the more the number of the connecting conductors 11 increases (in another point of view, the longer the connection region RC is in the y-direction), the more effectively a wider bandwidth is achieved.

However, when the number of the connecting conductors 11 is seven (from another point of view, when the connection region RC extends over substantially the entire length of the feed element 5 in the y-direction), the gain is reduced, although slightly, in a portion of the band (in the 28 GHz to 29 GHz range) where high gain is intended to be maintained. Here, in the example with seven connecting conductors 11, the distance from the outermost connecting conductors 11 to the edge 5b in the y-direction of the feed element 5 is about 1/20 (less than 1/10) of the length of the feed element 5 in the x-direction (½×λg). On the other hand, in the example with five connecting conductors 11, the distance from the outermost connecting conductors 11 to the edge 5b is about ⅕ ( 1/10 or more) of the length of the feed element 5 in the x-direction. Therefore, if the entirety of the connecting conductors 11 (in other words, the connection region RC) is distant from the edges 5b by a distance equal to or greater than 1/10 of the length of the feed element 5 in the x-direction, the probability of the gain reduction described above is reduced.

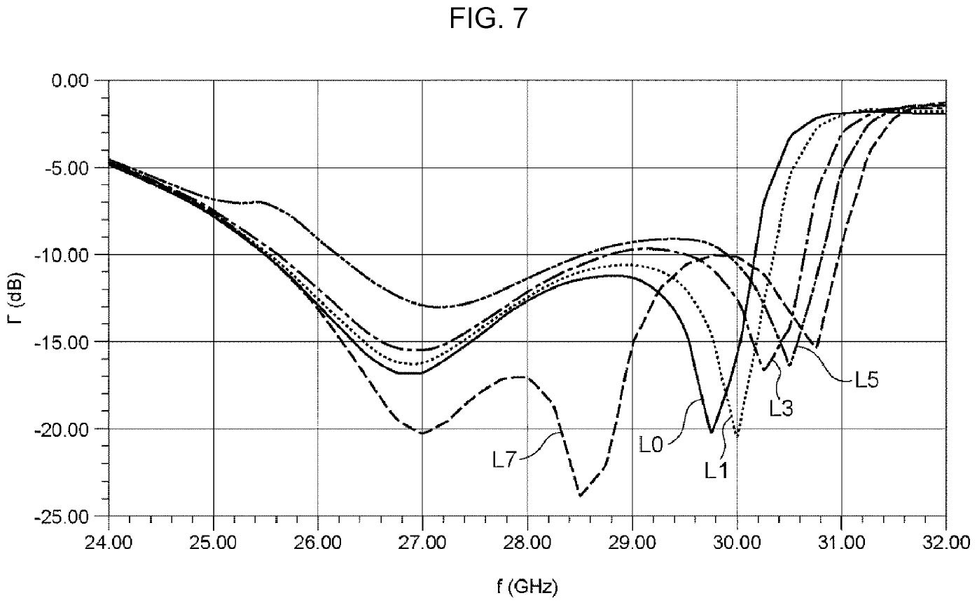

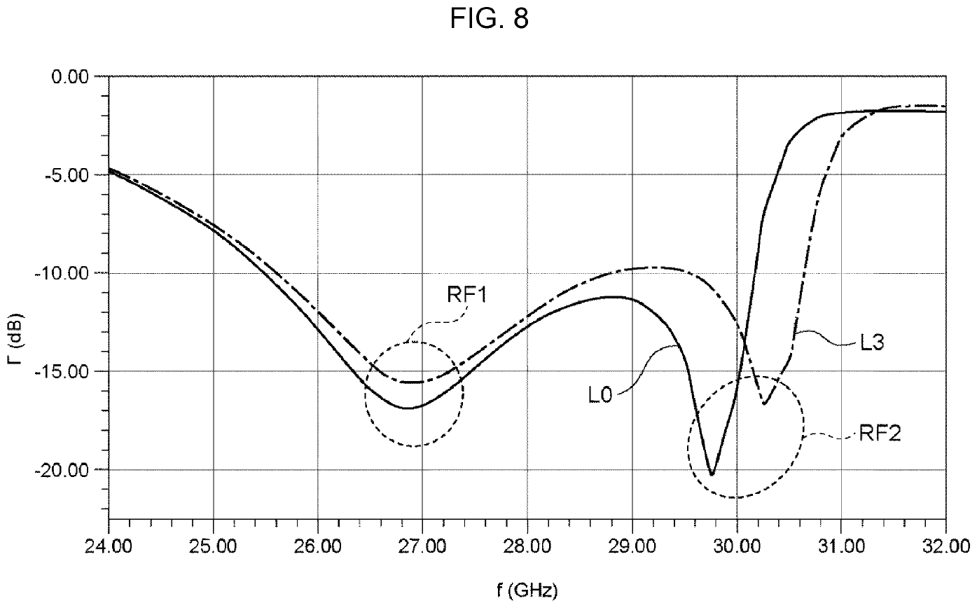

FIG. 7 is a graph showing the characteristics of the antennas of the examples and the comparative example. In the graph shown in FIG. 7, the horizontal axis represents the frequency f (GHz). The vertical axis represents the reflection coefficient Γ (dB). FIG. 8 is a graph showing a portion of FIG. 7. In these drawings, lines L0, L1, L3, L5 and L7 indicate the characteristics of the comparative example or examples with 0, 1, 3, 5 and 7 connecting conductors 11, similarly to FIG. 6.

In the antennas of the comparative example and the examples, a first resonance point RF1 and a second resonance point RF2 appear as indicated by the dotted lines in FIG. 8. As shown in FIG. 7, the first resonance point RF1 in the comparative example and the four examples appears at approximately the same frequency. On the other hand, as the number of the connecting conductors 11 increases, the second resonance point RF2 is located on the high frequency side. This fact indicates that the second resonance point RF2 is shifted to the high frequency side by the connecting conductor(s) 11, thus achieving a wider bandwidth.

In the example with seven connecting conductors 11 (line L7), a third resonance point (its sign is omitted) occurs in a range of 28 GHz to 29 GHz. The decrease in gain in the above frequency range in FIG. 6 is attributed to the effect of the third resonance point.

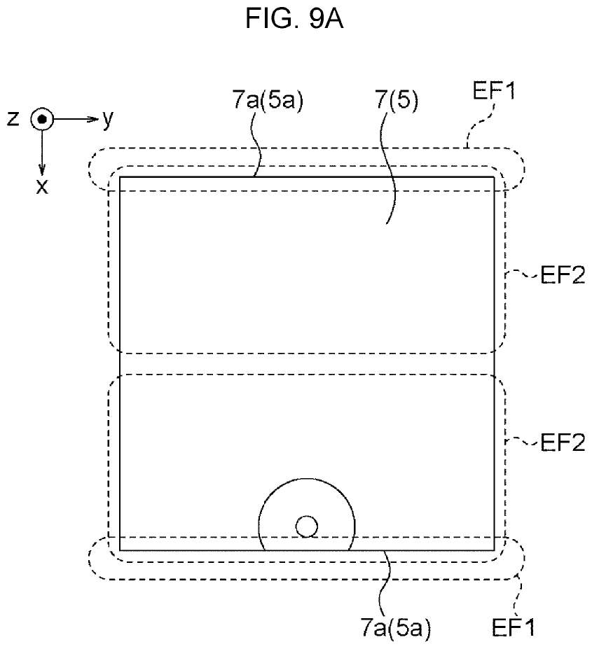

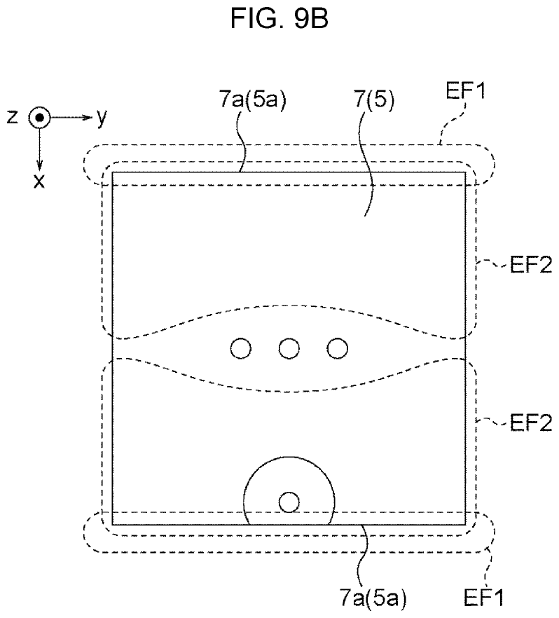

FIGS. 9A and 9B are plan views schematically illustrating electric field distributions obtained in the above simulation calculations.

FIG. 9A illustrates the electric field distribution of the comparative example. FIG. 9B illustrates the electric field distribution of the example with three connecting conductors 11. A first electric field region EF1 represents a region where the intensity of the electric field fluctuates significantly at the frequency of the first resonance point RF1. A second electric field region EF2 represents a region where the intensity of the electric field fluctuates significantly at the frequency of the second resonance point RF2. Note that in this drawing the shape of part of the actual electric field distribution is simplified and the shape of another part of the actual electric field distribution is exaggerated.

In plan view, the first electric field region EF1 is a region extending along the edges 5a on both sides of the feed element 5 (the edges 7a on both sides of the parasitic element 7) in the x-direction. The position and extent of the first electric field region EF1 did not differ significantly between the comparative example and the examples.

On the other hand, the second electric field region EF2 is a region extending from the edge 5a of the feed element 5 to the center of the feed element 5. The position and extent of the second electric field region EF2 were different between the comparative example and the example. Specifically, the example had a reduced width of the second electric field region EF2 on the central side in the x-direction compared to the comparative example. In other words, the length of the second electric field region EF2 in the x-direction was reduced.

From the above fact, when the connecting conductor(s) 11 is (are) provided, the length of the second electric field region EF2 in the x-direction is reduced, so that the second resonance point RF2 is shifted to the high frequency side.

### Summary of First Embodiment

As described above, the antenna 1 of the present embodiment includes the reference potential layer 3, the feed element 5, the parasitic element 7, and at least one connecting conductor 11. The reference potential layer 3 extends in the first direction (x-direction) and the second direction (y-direction) orthogonal to the x-direction. The feed element 5 is composed of a layered conductor facing the reference potential layer 3. The feed element 5 includes a first feed point (the feed point 17) located toward one side (+ x side) in the x-direction relative to the center of the feed element 5 in the x-direction. The parasitic element 7 is composed of a layered conductor facing the feed element 5 from a side opposite the reference potential layer 3. The connecting conductor(s) 11 is (are) connected to the feed element 5 and the parasitic element 7 at a position closer to the center of the feed element 5 than the feed point 17 in the x-direction, and is (are) not electrically connected to the reference potential layer 3.

Thus, for example, as described with reference to FIGS. 6 to 9, by reducing the width of the second electric field region EF2 toward the center in the x-direction, the second resonance point RF2 can be shifted to the high frequency side, and thus the frequency band with high gain can be widened to the high frequency side. In other words, a wider bandwidth can be achieved. The antenna 1 is not intended to discharge due to grounding of the parasitic element 7 and does not require a conductor to connect the parasitic element 7 to the reference potential layer 3, and therefore is simpler than a configuration that includes such a conductor.

The antenna 1 may have the first dielectric layer 15A and the second dielectric layer 15B. The first dielectric layer 15A may be interposed between the reference potential layer 3 and the feed element 5. The second dielectric layer 15B may be interposed between the feed element 5 and the parasitic element 7. The at least one connecting conductor 11 may include a connecting conductor 11 that is composed of a via conductor that passes through the second dielectric layer 15B.

In such a case, for example, the connecting conductor 11 can be configured by a via conductor of a known circuit board. As a result, manufacturing costs are reduced, for example. Further, the dielectric 13 can also shorten the effective wavelength so as to reduce the size of the antenna 1.

When viewed in a transparent plan view, the edges 5a on both sides of the feed element 5 in the x-direction and the edges 7a on both sides of the parasitic element 7 in the x-direction may overlap. The entirety of the connecting conductor(s) 11 may be located within a central length range of the feed element 5 obtained when the length of the feed element 5 in the x-direction is divided into five equal parts.

In such a case, for example, when the lengths of the feed element 5 and the parasitic element 7 in the x-direction are matched, multiple resonances are preferably caused. On the other hand, the probability of the connecting conductor(s) 11 interfering excessively with the second electric field region EF2 is reduced because the position of the connecting conductor(s) 11 in the x-direction is limited within a range of ⅕ of the length of the feed element 5 and the parasitic element 7 in the x-direction. As a result, for example, a wider bandwidth can be achieved while reducing the probability of characteristic degradation caused by the connecting conductor(s) 11.

The at least one connecting conductor 11 may include a plurality of connecting conductors 11 whose positions in the y-direction differ from each other.

In such a case, as shown in FIG. 6, for example, a wider bandwidth is achieved than in the case where the number of the connecting conductor(s) 11 is one. Further, the connection region RC expands easily in the y-direction in terms of the manufacturing method, compared to, for example, a configuration in which a plate-shaped connecting conductor 11C is formed as in the variation in FIG. 5A.

The entirety of the plurality of connecting conductors 11 may be distant from the edges 5b on both sides of the feed element 5 in the y-direction by a distance equal to or greater than 1/10 of the length of the feed element 5 in the x-direction (½×λg).

In such a case, as described with reference to FIG. 6, the probability of a slight gain reduction (see the change in line L7 at frequency 28 GHz-29 GHz) in the frequency band where the gain is intended to be maintained high is reduced. Obviously, when widening the bandwidth is prioritized over reducing the probability of such gain reduction, the distance from the edge 5b as described above need not be ensured.

The plurality of connecting conductors 11 may be equally spaced in the y-direction.

In such a case, for example, the reduction of the second electric field region EF2 in the x-direction is likely to be more uniformed over the entire length of the connection region RC in the y-direction. As a result, for example, the probability of noise caused by disturbances in the electric field is reduced.

Each of the feed element 5 and the parasitic element 7 may be rectangular in plan view, with two sides parallel to the x-direction and two sides parallel to the y-direction. The plurality of connecting conductors 11 may be arranged in a straight line in the y-direction within a central length range of the feed element 5 obtained when the length of the feed element 5 in the x-direction is divided into five equal parts.

In such a case, the plurality of connecting conductors 11 is arranged parallel to the edges 5a on both sides of the feed element 5 in the x-direction (the edges 7a on both sides of the parasitic element 7 in the x-direction). As a result, for example, the probability of disorder in the shape of the second electric field region EF2, whose length in the x-direction is reduced by the plurality of connecting conductors 11, is reduced. Since the range of the connecting conductors 11 in the x-direction is limited within the range of ⅕ of the lengths of the feed element 5 and the parasitic element 7 in the x-direction, the probability of the connecting conductors 11 interfering excessively with the second electric field region EF2 is reduced. As a result, for example, a wider bandwidth can be achieved while the probability of characteristic degradation due to the provision of the connecting conductor(s) 11 is reduced.

The at least one connecting conductor 11 may include a connecting conductor 11 whose length in the x-direction is equal to or greater than 1/10 of the length of the feed element 5 in the x-direction. In another point of view, the length of the connection region RC in the x-direction may be equal to or greater than 1/10 of the length of the feed element 5 in the x-direction.

In such a case, for example, the effect of reducing the length of the second electric field region EF2 in the x-direction is more likely to be achieved reliably. In the technique of grounding the parasitic element 7 for reducing noise caused by charging of the parasitic element 7, such as the technique described in Patent Literature 1, the size of the connecting conductor 11 in the x-direction is made as small as possible so that the antenna characteristics are not changed.

The above at least one connecting conductor may include a connecting conductor 11C whose length in the y-direction is equal to or greater than twice the length in the x-direction (the variation of FIG. 5A).

In such a case, for example, compared to the configuration in which a plurality of cylindrical connecting conductors 11 is arranged, the gap between the connecting conductors 11 is not generated (or is reduced), so that the length of the second electric field region EF2 in the x-direction can be reduced uniformly in the y-direction. As a result, the characteristics are improved.

### Second Embodiment

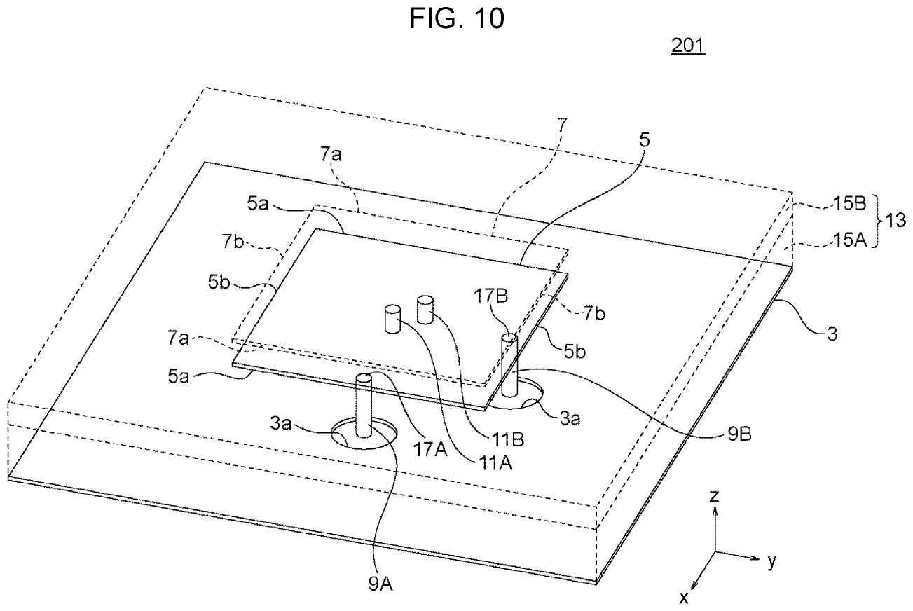

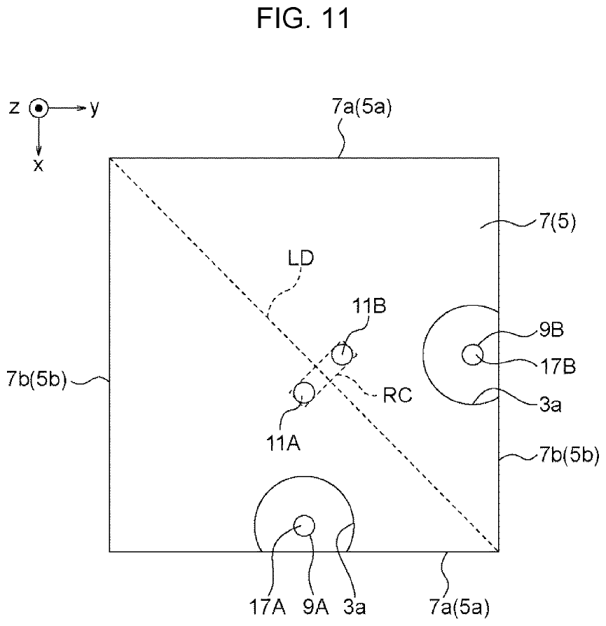

FIG. 10 is a perspective view illustrating a configuration of an antenna 201 of a second embodiment, and is equivalent to FIG. 1. FIG. 11 is a transparent plan view illustrating a portion of the antenna 201, and is equivalent to FIG. 3.

Basically, only the differences from the first embodiment will be described below. Matters not particularly described may be assumed to be the same as and/or similar to those in the first embodiment, or may be estimated from the first embodiment.

The antenna 201 is configured to transmit and/or receive two types of linearly polarized waves whose oscillation directions cross each other (for example, are orthogonal to each other). One of the two linearly polarized waves has the x-direction as the oscillation direction of the electric field, as in the first embodiment. The other of the two linearly polarized waves has the y-direction as the oscillation direction of the electric field, and this is a point different from the first embodiment.

The antenna 201 capable of transmitting and/or receiving two linearly polarized waves as described above can be used, for example, as an antenna capable of transmitting and/or receiving both a vertically polarized wave and a horizontally polarized wave. Further, for example, the antenna 201 can be used to transmit and/or receive a circularly polarized wave.

The antenna 201 includes, corresponding to the linearly polarized wave in the x-direction, a feeding conductor 9A (with associated feed point 17A and opening 3a) and connecting conductors 11A and/or 11B. These components are the same as and/or similar to the feeding conductor 9 and the connecting conductor 11 of the antenna 1. Furthermore, the antenna 201 includes, corresponding to the linearly polarized wave in the y-direction, a feeding conductor 9B (with associated feed point 17B and opening 3a) and the connecting conductors 11B and/or 11A. These components are also the same as and/or similar to the feeding conductor 9 and connecting conductor 11 of the antenna 1, except that the meaning of the x-direction and the meaning of the y-direction are opposite each other. In the following description, A and B may be omitted.

In the example illustrated in the drawings, a feed element 5 and a parasitic element 7 are squares that coincide with each other in a transparent plan view. The feeding conductor 9A and connecting conductor 11A and the feeding conductor 9B and connecting conductor 11B are in a line symmetrical relationship with respect to a diagonal LD of the feed element 5 (the parasitic element 7). A straight line (not illustrated) connecting the feeding conductor 9A and the connecting conductor 11A and a straight line (not illustrated) connecting the feeding conductor 9B and the connecting conductor 11B are, for example, orthogonal to each other, and their intersection is, for example, at the center of the feed element 5.

The connecting conductor 11A may contribute to obtaining a wider bandwidth with respect to the linearly polarized wave in the x-direction, or to obtaining a wider bandwidth with respect to the linearly polarized wave in the y-direction, or to obtaining both. In the example illustrated in the drawings, the connecting conductor 11A falls in a central range of the feed element 5 in the x-direction obtained when the length of the feed element 5 in the x-direction is divided into three equal parts. However, part of the connecting conductor 11A protrudes from the central range obtained when the length of the feed element 5 in the x-direction is divided into five equal parts. In the y-direction, the connecting conductor 11A is located in the center of the feed element 5 in the y-direction. The connecting conductor 11A has been discussed above; and such a description may be applied to the connecting conductor 11B when substituting A for B and x for y.

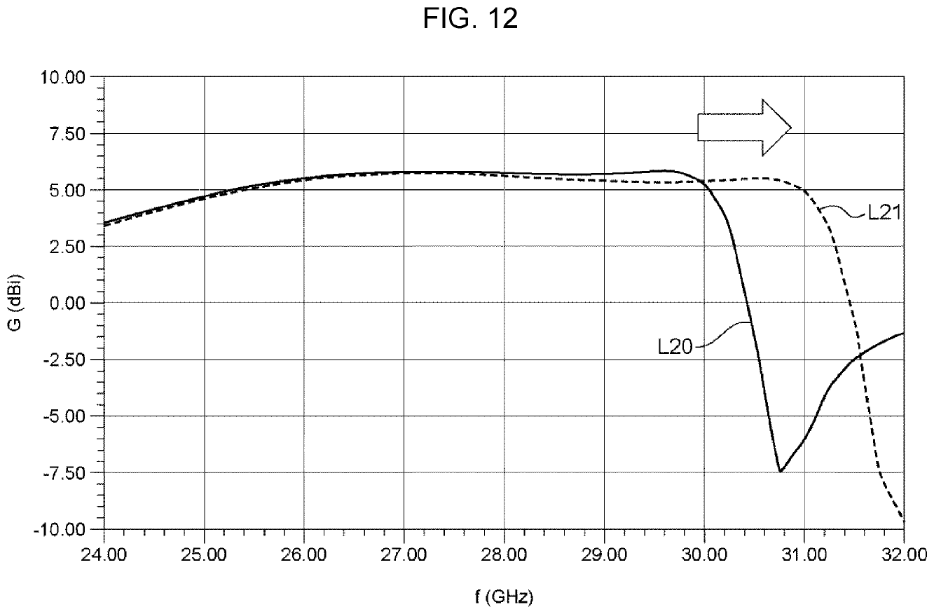

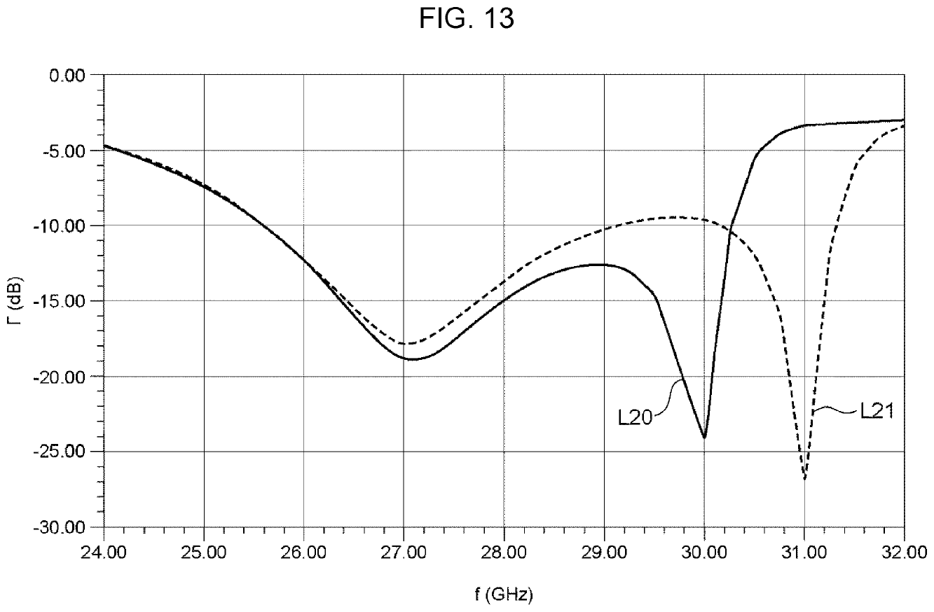

FIGS. 12 and 13 are graphs showing the characteristics of the antennas of an example and a comparative example, and are equivalent to FIGS. 6 and 7.

The line L20 indicates the characteristics of the comparative example. The antenna of the comparative example is obtained by eliminating the connecting conductors 11A and 11B from the antenna 201. The line L21 indicates the characteristics of the example (the antenna 201).

These drawings confirm that the same and/or similar effects as in the first embodiment are obtained also in the second embodiment. As described above, part of the connecting conductor 11A protrudes from a central range obtained when the length of the feed element 5 in the x-direction is divided into five equal parts; however, these drawings confirm that, even in such a case, a wider bandwidth can be achieved while the gain equivalent to that of the comparative example is maintained.

Although not particularly illustrated in the drawings, the second embodiment may be changed in various ways. For example, the number of the connecting conductors 11 may be one. For example, one connecting conductor 11 may be arranged in the center of the feed element 5. Three or more connecting conductors 11 may be arranged, or a connecting conductor 11 that is not circular in plan view may be arranged. The various examples described in the first embodiment may be applied when the x-direction of the first embodiment is equated with the x-direction of the second embodiment. Similarly, the various examples described in the first embodiment may be applied when the x-direction of the first embodiment is equated with the y-direction of the second embodiment. The configuration focused on the x-direction may be different from the configuration focused on the y-direction (i.e. these configurations need not be rotationally or linearly symmetric).

As described above, in the present embodiment, the antenna 201 also includes the reference potential layer 3, the feed element 5, the parasitic element 7, and at least one connecting conductor 11 (the conductor 11A and the conductor 11B). The reference potential layer 3 extends in the first direction (x-direction) and the second direction (y-direction) orthogonal to the x-direction. The feed element 5 is composed of a layered conductor facing the reference potential layer 3. The feed element 5 includes a first feed point (the feed point 17A) located at a position toward one side (+x side) in the x-direction relative to the center of the feed element 5 in the x-direction. The parasitic element 7 is composed of a layered conductor facing the feed element 5 from a side opposite the reference potential layer 3. The connecting conductor 11 is connected to the feed element 5 and the parasitic element 7 at a position closer to the center of the feed element 5 than the feed point 17A in the x-direction, and is not electrically connected to the reference potential layer 3.

Therefore, the same and/or similar effects as in the first embodiment are achieved. For example, as shown in FIGS. 12 and 13, a wider bandwidth is achieved.

The feed element 5 may further include a second feed point (the feed point 17B) located at a position toward one side (+y side) in the y-direction. The feed element 5 and the parasitic element 7 may each be square. The feed points 17A and 17B may be in a line symmetrical positional relationship with respect to one diagonal LD of the square of the feed element 5. The at least one connecting conductor 11 (the connecting conductor 11A and the connecting conductor 11B) may be located at a position closer to the center of the feed element 5 than the feed point 17B in the y-direction and may be arranged line symmetrically with respect to the diagonal LD.

In such a case, as described above, two linearly polarized waves can be handled, and the same and/or similar effects as in the first embodiment can be obtained for each of the two linearly polarized waves. Furthermore, since the configuration is line symmetrical with respect to the diagonal LD, the characteristics related to the linearly polarized wave in the x-direction and the characteristics related to the linearly polarized wave in the y-direction can be made equivalent. When arranged in a line symmetrical manner, a plurality of connecting conductors 11 may be in a line symmetrical positional relationship as in the example illustrated in the drawings, or one connecting conductor 11 may be located on the diagonal line LD, different from the example illustrated in the drawings.

### <Applications>

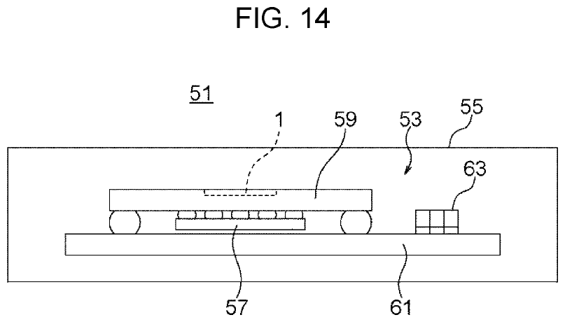

FIG. 14 is a view schematically illustrating a configuration of an electronic device 51 as an application of the antenna of an embodiment. Note that, for convenience, in the following description, the sign of the antenna 1 of the first embodiment is used, but the antenna 201 of the second embodiment may also be used for the electronic device 51.

The electronic device 51 may be in various forms. For example, the electronic device 51 may be a communication device. Examples of the communication device include a mobile terminal, a base station, a relay station, a LAN (wireless local area network) master unit, a satellite positioning system receiver, an antenna device attachable to and detachable from various electronic devices, a radio, a television, and in-vehicle equipment for ETC (electronic toll collection system). Examples of the mobile terminal include a mobile phone (including smartphone), a tablet PC (personal computer) or a notebook PC. Examples of the electronic device 51 other than the communication device include a radar device and a microwave oven. The following description is based on the assumption that the electronic device 51 is a communication device.

The electronic device 51 includes, for example, an antenna module 53 and a housing 55 that houses the antenna module 53.

The antenna module 53 includes, for example, an antenna 1 and a transmitter circuit that transmits radio waves via the antenna 1 and/or a receiver circuit that receives radio waves via the antenna 1. Such transmitter circuit and/or receiver circuit may be configured, for example, by one or more ICs 57. The IC 57 is, for example, a RF (radio frequency)—IC and is electrically connected to the lower end of a feeding conductor 9.

The transmitter circuit may, for example, perform frequency raising and modulation on a baseband signal containing certain information, and feed the high-frequency signal to the antenna 1 (more specifically, to the feeding conductor 9). Note that, when the antenna 201 is provided instead of the antenna 1, the transmitter circuit may selectively transmit two linearly polarized waves by, for example, selectively feeding power to two feeding conductors 9 (in another point of view, two feed points 17). More specifically, for example, the transmitter circuit may alternately output two linearly polarized waves in a predetermined period. Alternatively, only one of the two linearly polarized waves may be always transmitted according to user's settings (until the setting is changed). Different from the above description, the transmitter circuit may also supply a current that is 90° out of phase to two feeding conductors 9, so that a circularly polarized wave is transmitted.

The receiver circuit may, for example, perform frequency reduction and demodulation on a high-frequency signal from the antenna 1 to obtain a baseband signal containing certain information. Note that, when the antenna 201 is provided instead of the antenna 1, the receiver circuit may, for example, selectively use the current from the two feeding conductors 9 (in another point of view, the two feed points 17). More specifically, for example, the receiver circuit may always perform the above processing (demodulation and the like) on only one of the two currents according to user's settings (until the setting is changed). Alternatively, the receiver circuit may perform the above processing for only the larger one of the currents from the two feeding conductors 9. Different from the above description, the receiver circuit may also perform, for the currents from the two feeding conductors 9, processing the same as and/or similar to processing of a receiving circuit that receives a circularly polarized wave.

Any specific connection form is used between the IC 57 (the transmitter circuit and/or receiver circuit) and the antenna 1. In the example illustrated in the drawing, the antenna 1 is configured as part of the side of one main surface of an antenna substrate 59. The IC 57 is mounted on the other main surface of the antenna substrate 59. The feeding conductor 9 is electrically connected to the IC 57 via a conductor (conductor layer and/or via conductor) in the antenna substrate 59.

In the example illustrated in the drawing, the antenna module 53 includes, in addition to the antenna substrate 59 and the IC 57, a mounting substrate 61 on which the antenna substrate 59 is mounted, and electronic components 63 which are mounted on the mounting substrate 61. The IC 57 (the transmitter circuit and/or receiver circuit) may be a component mounted on the mounting substrate 61.

As will be understood from the examples of the various forms of the electronic device 51 (for example, a mobile terminal or the like) described above, the electronic device 51 is made of any material, and has any size and shape. The relative size of the antenna 1 and the electronic device 51 is also optional.

The technology according to the present disclosure is not limited to the above embodiments and may be implemented in various forms.

For example, the connecting conductor(s) 11 may be electrically connected to the reference potential layer 3. In other words, various novel concepts can be extracted from the present disclosure without the requirement that the connecting conductor(s) 11 is (are) electrically connected to the reference potential layer 3. For example, in the description of the embodiments, the antenna 1 may include a plurality of connecting conductors 11 with different positions in the y-direction from each other, and the length of the connecting conductor(s) 11 in the x-direction may be equal to or greater than 1/10 of the feed element 5 in the x-direction. From such a point of view, the concept of a novel antenna may be extracted, and in such a case the connecting conductor(s) 11 may or may not be grounded.

Also, for example, the antenna may or may not include a dielectric 13. For example, a space (air, in another point of view) may be provided between the feed element 5 and the parasitic element 7. The same is applied between the reference potential layer 3 and the feed element 5. Note that, if a dielectric layer is not interposed between two conductor layers facing each other, the conductor layers may be fixed to each other by, for example, insulating struts.

Also, for example, the antenna may or may not include a reference potential layer 3 (ground plate). For example, instead of the reference potential layer 3, the earth may be used, or a different member from the antenna may be used. Examples of the different member include, for example, a housing to which the antenna is fixed and a ground layer of a circuit board on which the antenna is mounted. However, in this case, the entirety, including the housing or the circuit board, may be perceived as the antenna.

The antenna may include components not described in the embodiments. For example, a conductor layer with a suitably shaped opening may be placed between the feed element 5 and the parasitic element 7 or above the parasitic element 7. Such a conductor layer, for example, functions as a filter.

The antenna may be used as an antenna constituting array antennas. For example, in the antenna substrate 59 illustrated in FIG. 14, a plurality of antennas may be arranged along the upper surface of the antenna substrate 59.

### REFERENCE SIGNS

1 antenna
3 reference potential layer
5 feed element
7 parasitic element
11 connecting conductor
17 feed point

1. An antenna comprising:
a reference potential layer extending in a first direction and a second direction orthogonal to the first direction;
a feed element composed of a layered conductor facing the reference potential layer and comprising a first feed point at a position toward one side in the first direction relative to a center of the feed element in the first direction;
a parasitic element composed of a layered conductor facing the feed element from a side opposite the reference potential layer; and
at least one connecting conductor connected to the feed element and the parasitic element at a position closer to the center of the feed element than the first feed point in the first direction, the at least one connecting conductor not electrically connected to the reference potential layer.

2. The antenna according to claim 1, further comprising:
a first dielectric layer interposed between the reference potential layer and the feed element; and
a second dielectric layer interposed between the feed element and the parasitic element,
wherein
the at least one connecting conductor comprises a connecting conductor composed by a via conductor passing through the second dielectric layer.

3. The antenna according to claim 1, wherein
when viewed in transparent plan view, both edges of the feed element in the first direction overlap both edges of the parasitic element in the first direction, and
when viewed in transparent plan view, an entirety of the at least one connecting conductor falls in a central length range of the feed element obtained when a length of the feed element in the first direction is divided into five equal parts.

4. The antenna according to claim 1, wherein the at least one connecting conductor comprises a plurality of connecting conductors whose positions in the second direction are different from each other.

5. The antenna according to claim 4, wherein an entirety of the plurality of connecting conductors is distant from both edges of the feed element in the second direction by a distance equal to or greater than 1/10 of a length of the feed element in the first direction.

6. The antenna according to claim 1, wherein the plurality of connecting conductors is equally spaced in the second direction.

7. The antenna according to claim 1, wherein
each of the feed element and the parasitic element is rectangular in plan view, having two sides parallel to the first direction and two sides parallel to the second direction, and
the plurality of connecting conductors is disposed in a straight line in the second direction within a central length range obtained when the length of the feed element in the first direction is divided into five equal parts.

8. The antenna according to claim 1, wherein the at least one connecting conductor comprises a connecting conductor whose length in the first direction is equal to or greater than 1/10 of a length of the feed element in the first direction.

9. The antenna according to claim 1, wherein the at least one connecting conductor comprises a connecting conductor whose length in the second direction is equal to or greater than twice a length in the first direction.

10. The antenna according to claim 1, wherein
the feed element further comprises a second feed point located at a position toward one side of the feed element in the second direction,
the feed element and the parasitic element are each square,
the first feed point and the second feed point are in a line symmetrical positional relationship with respect to one diagonal line of the square of the feed element, and
the at least one connecting conductor is located at a position closer to a center of the feed element in the second direction than the second feed point, and is disposed in line symmetry with respect to the one diagonal line.

11. An antenna comprising:
a feed element composed of a layered conductor extending in a first direction and a second direction orthogonal to the first direction, and comprising a first feed point at a position toward one side in the first direction relative to a center of the feed element in the first direction;
a parasitic element composed of a layered conductor facing the feed element; and
at least one connecting conductor connected to the feed element and the parasitic element at a position closer to the center of the feed element than the first feed point in the first direction,
wherein the at least one connecting conductor comprises a plurality of connecting conductors whose positions in the second direction are different from each other.

12. An antenna comprising:
a feed element composed of a layered conductor extending in a first direction and a second direction orthogonal to the first direction, and comprising a first feed point at a position toward one side in the first direction relative to a center of the feed element in the first direction;
a parasitic element composed of a layered conductor facing the feed element; and
at least one connecting conductor connected to the feed element and the parasitic element at a position closer to the center of the feed element than the first feed point in the first direction,
wherein the at least one connecting conductor comprises a connecting conductor whose length in the first direction is equal to or greater than 1/10 of a length of the feed element in the first direction.

13. An antenna module comprising:
an antenna according to claim 1; and
an IC connected to the first feed point.

14. An electronic device comprising:
an antenna module according to claim 13; and
a housing that houses the antenna module.
